(19) United States
(12) Patent Application Publication
(10) Pub. No.: US 2002/0054155 A1
(43) Pub. Date: May 9, 2002

(54) Data module design system

(75) Inventors: John Edward Churchill, Boulder Creek, CA (US); Rick Nadler, Santa Cruz, CA (US); Charles Jazdzewski, Soquel, CA (US)

Correspondence Address: DARBY & DARBY P.C., 805 Third Avenue, New York, NY, 10022, US

(73) Assignee: Borland Software Corporation

(21) Appl. No.: 09/906,401

(22) Filed: Jul. 16, 2001

Related U.S. Application Data
(60) Provisional application No. 60/225,054, filed on Aug. 14, 2000.
(60) Provisional application No. 60/218,282, filed on Jul. 14, 2000.

(51) Int. Cl. G09G 5/00

(52) U.S. Cl. 345/826

(57) ABSTRACT

A method for designing a data module presents a series of components in a parentage view of a window on a display, the parentage view being hierarchically arranged with each component occupying a respective position in the hierarchy. A user is enabled to drag one or more of the components displayed in the parentage view into a new position within the hierarchy. As a result, the relationship data among the components in the data module are automatically rearranged once the components are dropped into their respective new positions in the hierarchy.

This patent application claims the benefit of priority under 35 U.S.C. §119 from U.S. Provisional Application Ser. No. 60/225,054, filed Aug. 14, 2000, entitled “A Data Module Design System and Frame Component Container,” and from U.S. Provisional Application Ser. No. 60/218,282, filed Jul. 14, 2000, entitled “A Data Module Design System and Frame Component Container,” each of which is incorporated by reference as if set forth in its entirety herein.

### FIELD OF THE INVENTION

The present invention relates generally to improvements in data module design for use in object orientated environments. More particularly, the present invention relates to graphically based methods for manipulating relationships between software objects.

### BACKGROUND OF THE INVENTION

Traditionally, data modules are designed from a component view perspective, using integrated development environments such as Delphi 4.0, a developer tool produced by Borland Software Corporation of Scotts Valley, Calif. Data modules are a special type of form that contain non-visual components, and are a convenient organizational tool because they can be used to isolate parts of an application that handle database connectivity and business rules. Forms define an application interface; developers define the properties and code the event handlers of the forms.

The data module is a convenient construct if groups of database and system objects are to be reused. There is a need, however, for improved systems for designing data modules. Further, there is a need for a tool that provides a developer with flexibility in defining data modules and their relationships among other database elements. The present invention provides such improvements by providing a hierarchical relationship view to a data module which can be augmented or rearranged through intuitive drag and drop operations, thereby extending known integrated development environments.

### SUMMARY OF THE INVENTION

In accordance with a salient aspect of the invention, a method for designing a data module is described in which a series of components of a data module are presented in a parentage view of a window on a display, the parentage view being hierarchically arranged with each component occupying a respective position in the hierarchy. A user is enabled to drag one or more of the components displayed in the parentage view into a new position within the hierarchy. As a result, the relationship data among the components in the data module are automatically rearranged once the components are dropped into their respective new positions in the hierarchy.

In a particular implementation, the parentage view is presented in a first pane of the window along with at least one additional view. The additional view can be a component view which presents graphic representations of the database element components that are included in the hierarchy. These graphic representations can be positioned and organized within the component view by the user.

Optionally, the method includes the additional step of confirming that a parentage change that would result from dropping one or more of the components from the palette into the new position is appropriate, prior to rearranging any of the existing relationship data.

These and other features, aspects, and advantages of the present invention can be appreciated from the following Detailed Description of Certain Preferred Embodiments and accompanying Drawing and Figures.

### BRIEF DESCRIPTION OF THE DRAWINGS

FIG. 1 is a user interface for a data module design system showing a component view in an active window pane along side a tree view in accordance with a preferred embodiment of the present invention.

FIG. 2 is the user interface of FIG. 1, now showing the tree view alongside a data diagram view.

FIGS. 3A-3C are flowcharts for designing a data module in a visual integrated development environment system.

### DETAILED DESCRIPTION OF CERTAIN PREFERRED EMBODIMENTS

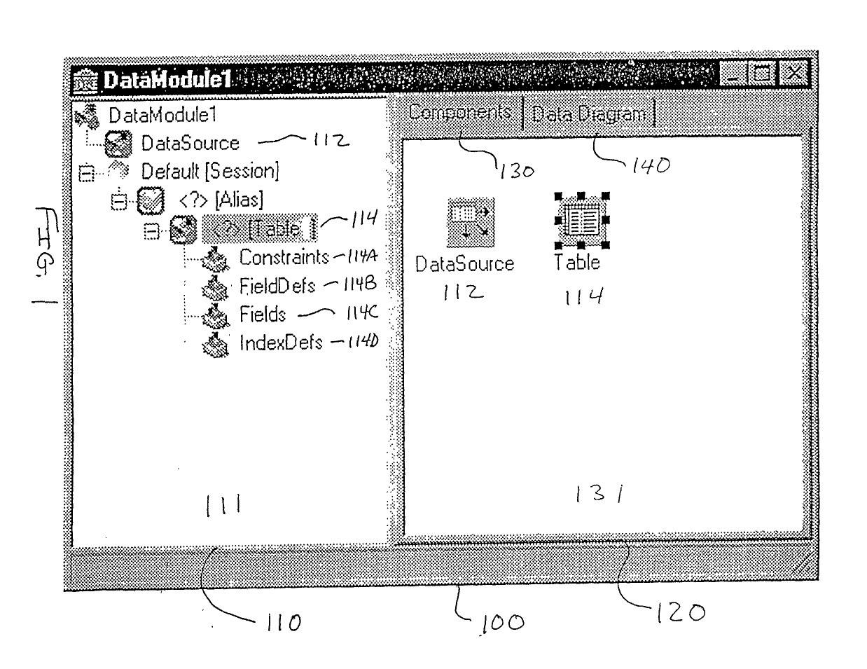

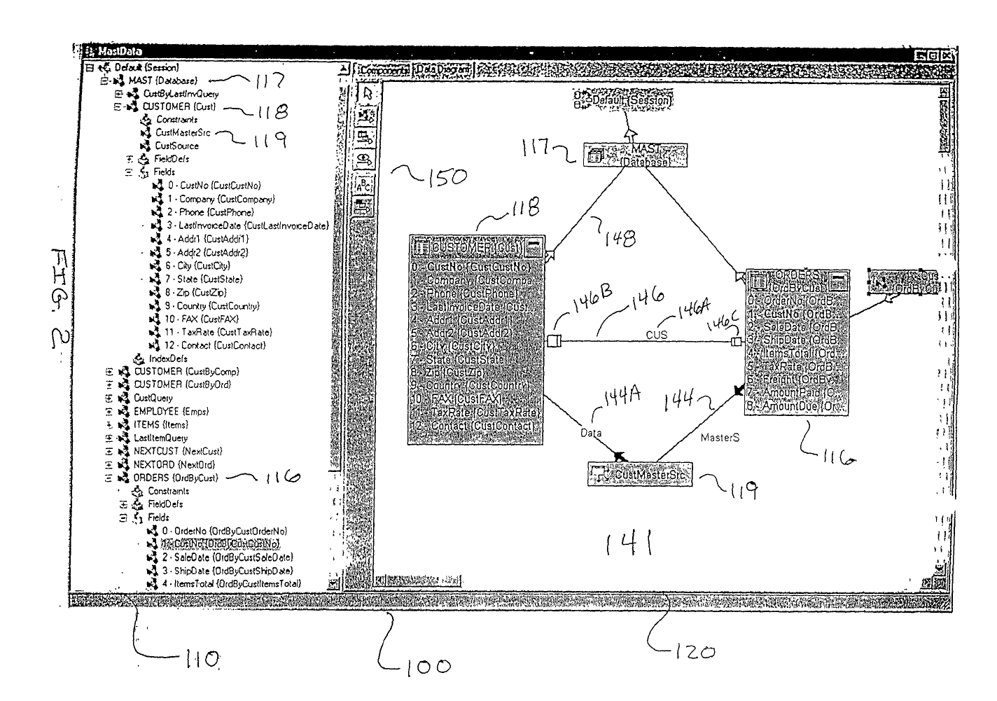

By way of overview and introduction, the invention provides a new graphical perspective and functionality to integrated development environments (IDEs). In particular, the data module design system 100 is an active window displayable to a user which includes at least two panes (see FIG. 1), a first pane 110 which displays a tree-view 111 of the hierarchical relationships among data access components (“objects”) and a second pane 120 which can be configured, by selecting tabs 130, 140 to display the (traditional) component view 131 of the objects, or a data diagram view (see FIG. 2, 141). These views are described below. Using the interface of the preferred embodiment, users can drag and drop objects from the palette directly onto the component view 131, these components will appear on the root node of the tree view 111. Users can drag and drop objects from a component palette (not shown) directly into the tree-view 111, with new relationships and dependencies being automatically defined. These changes to the underlying relationships can be performed both before and after compilation of the data access components and therefore provide great flexibility to the data module designer.

Two distinct views of the components in a data module under design are therefore provided by the data design system 100, as shown in FIG. 1. Preferably, the visible portions of the two views are synchronized to show the same elements in their own respective views. For example DataSource 112 in the component view 131 is the same element shown in the tree view 111. Also, Table 114 is shown in both the component view 131 and the tree view 111. Thus the views of the two panes 110, 120 are synchronized.

The “parentage” or tree view 111 shows the parent relationship among adjacent objects 112, 114. The parent-child relationship among certain components of a data module are well known. For example, databases fall under sessions, datasets fall under databases, menu items fall under menus (and other menu items), fields (e.g. Fields 114C) fall under a table 114, and actions fall under action lists. The parentage view 111 permits direct drag and drop editing of these relationships for rapid changes in overall data module design. For example, data sources can be dragged from one table to another, databases can be dragged from one session to another, and datasets—such as tables and queries—can be dragged from one database to another. A drag and drop operation is not permitted where the parentage change is nonsensical. For example, a user cannot change the parent of a menu item to an action list. A benefit flowing from the parentage view 111 is that users can edit child components directly free of a dedicated editor program.

The drag and drop behavior of a given component is determined by selecting one of its properties as can be discerned and edited using an object inspector. However, not until the component is dropped is a determination made as to whether the parentage change that would result from dropping that component into a new position would be appropriate. If the proposed drop location would amount to an attempt to change the parent of one component type to that of an incompatible component type, then the drag and drop operation would not result in any rearrangement of the relationship data among the various data modules in the application interface.

For more operations concerning drag and drop operations, see Microsoft Mouse Programmer's Reference, Microsoft Press, 1989, the disclosure of which is hereby incorporated by reference.

Such drag and drop rearrangement of database element interrelationships can be made strictly within the single pane of the parentage view 111. Preferably, however, a second pane 120 is provided which provides additional views of the database elements, and these views can be tapped to engraft additional database elements to the data module, for example, from a component view 131, as described next.

A number of components can be included into the data module under construction and made visible in the second pane 120 by selecting the component view tab 130. As components are dropped from the component palette into the tree view 111, the component becomes associated with the item it is dropped onto, to the extent appropriate. Thus, for example, if a new data source is dropped onto a table in the tree view, the data source automatically becomes a child of that table by setting its dataset property to the name of the table. Components can be added to the data module under construction by drag and drop inclusion into the window 100 from a component palette or obtained from a component list window by highlighting single or multiple component classes and clicking an “okay” button.

When components are dropped into or moved within the tree view 111, their relationships to other objects and their properties are amended automatically to account for their new position in the hierarchy. However, if one of the components is defective or not completely defined (e.g., a datasource has a dataset property with no value), then the tree view 111 preferably highlights that node to the user, for example, by showing a red outline around that object. When a component in the tree view is selected, its properties can be edited using an object inspector. See, for example, U.S. Pat. No. 5,502,805, which is hereby incorporated by reference in its entirety as if set forth herein for details concerning an object inspector. In particular, when a component is selected, the object inspector can be used in a conventional manner to display (and when appropriate edit) the published properties of that component. Properties and their present values are maintained by the object inspector.

As shown in FIG. 1, the second pane 120 includes several tabs (130, 140). Selection of a tab causes a particular view to be displayed. For example in the preferred embodiment there are two tabs, Components 130 and Data Diagram 140. Selection of the Components tab 130 will cause the view to display the component view 131 and the module's components. Selection of the Data Diagram tab 140 will cause the view to display the data diagram view (see FIG. 2, 141).

A data module is created by adding a new, empty module to the current project in the integrated development environment (IDE) and by displaying a file for the new module in a code editor. Existing modules are opened within the data module design system and are presented to the user in a window of the type shown in FIG. 1. Various methods can be used to define event handlers and to work with helper objects such as lists, window registry and .INI files, and to stream data to storage devices. These techniques are known in the art and form no part of the present invention.

The data module contains non-visual components. Components can be added to the data module, for example, by selecting them from a component palette and dragging them into the tree or components view (111, 131). The data module provides a convenient organizational tool to isolate parts of an application that handle database connectivity and business rules. The data module also makes it convenient to reuse groups of databases and system objects.

If a new data module is opened by a user of the data module system, the system opens an empty data module unit in a window 100, displays a unit file for the new module in a code editor, and adds the new module to the current project. Methods can be written to this unit file. These methods may be event handlers for the components in the module, as well as global routines encapsulating business routines. For example, a procedure to perform monthly bookkeeping can be called from an event handler for a component in the module or from any unit that uses the module.

A data module may be of either a standard or a remote type. A standard data module is used to create either a single- or two-tiered application. To create a multi-tiered application, for instance a client/server application, a remote data module can be added to the application server. A remote data module has an interface that clients in a multi-tiered application access across networks.

With reference now to FIG. 2, the data diagram view 141 provides a visual tool for setting up and editing relationships among database elements and for creating associated documentation. The data diagram provides a graphic view of the relationships and dependencies among the components. The data diagram is also a documentation tool allowing illustration of these relationships and permitting the designer to append comments to the diagram. In the preferred embodiment, relationships are represented by lines on the data diagram view 141. The data diagram view shows several types of relationships among database elements including their property relationships 144, master-detail relationships 146, and parent relationships 148. The data diagram view also supports allude relationships, and look-up relationships. Where applicable, the data diagram view permits direct modification of such relationships. Relationships can be deleted from the project by removal of the representational line.

The property relationship 144 illustrates all of the properties of a component and its relationships to other components. Property relationships are represented by solid arrows that point away from the component that includes a particular property and point toward the component referred to by the property. A selected component may have one or more properties that reference a targeted component. The name of the property is shown as the caption 144A of the arrow.

A property relationship 144 forms between components when any property of one component refers to any of another component's properties. A selected component may have one or more properties that reference or target a component. These property relationships are represented by lines with a solid arrow 144 pointing away from the component containing a property and towards the component referred to by that property. A property relationship can be formed by the user clicking on the property tool button of the relationship toolbar 150 of the data diagram view. Click the component that has the property and drag to the component that will be referred to by that property. A user would drag from a data source to a table. If the selected component has only one property that can reference the target, no additional information is needed. If more than one property could point to the target, a pop-up menu will be displayed allowing the user selection of the dataset. For example in FIG. 2 the Order table 116 refers to a property in the Customer table 118 via the CustMasterSrc data source 119.

The master-detail relationship 146 represents the hierarchy between a table component as a detail dataset and corresponding master dataset. In the preferred embodiment, the master-detail relationship 146 is represented by lines with asymmetric drum glyphs at either end. The larger drum 146B denotes the master data set and the smaller drum 146C denotes the detail dataset of the master-detail relationship. The value of the detail dataset's Masterfields property is shown as a caption 146A. The data module designer automatically generates a required data source when a master-detail relationship is created. Subsequent removal of the master-detail relationship 146 does not delete these data sources from the project. However, deletion of a required data source automatically removes the master-detail relationship 146. Selection of the master-detail tool button of the relationship toolbar 150 will allow the user to graphically create relationships. The user clicks on the table component that will be the detail dataset and drags the pointer to the component that will be the master dataset. For example, the master data set, Customer 118, is pointing towards the detail dataset, Orders 116.

The parent relationship 148 is the data diagram view's representation of the tree view hierarchy 111. The parent relationship 148 of one element 118, appearing below another element 117 in the tree view 111, is represented in the preferred embodiment of the data diagram view 141 by a line 148 with a hollow arrow pointing from the child to the parent.

An allude relationship is a non-programmatic relationship that permits a real world or commentary linkage between two objects. An allude relationship can be included in the data diagram view, for example, in the form of an arrow pointing from one item in the data diagram view 141 to another. An allude relationship assists in documentation creation and has no effect on the operation of the data module being made by the user. An allude relationship can be used in conjunction with comment blocks to annotate the data diagram. An allude relationship can be created by selecting the comment allude tool button of the relationship toolbar 150 and clicking an item in the data diagram view and dragging to another item. The ends of an allude arrow may be repositioned as necessary and the middle of the arrow may be bent. The ends of the allude arrow may also be changed and reorientated.

A look-up relationship is represented by lines with an “eye” glyph next to the lookup dataset. A lookup field is created in a dataset and the name of the lookup field is shown as the caption of the line. Removal of the look-up relationship causes the lookup field to be deleted. A look-up relationship is created by the user selecting the look-up tool button of the relationship toolbar 150. Clicking on the dataset for which the user wants to create a lookup field and dragging to the look-up dataset creates the relationship. When a look-up relationship is created, the New Field dialogue appears requesting additional information.

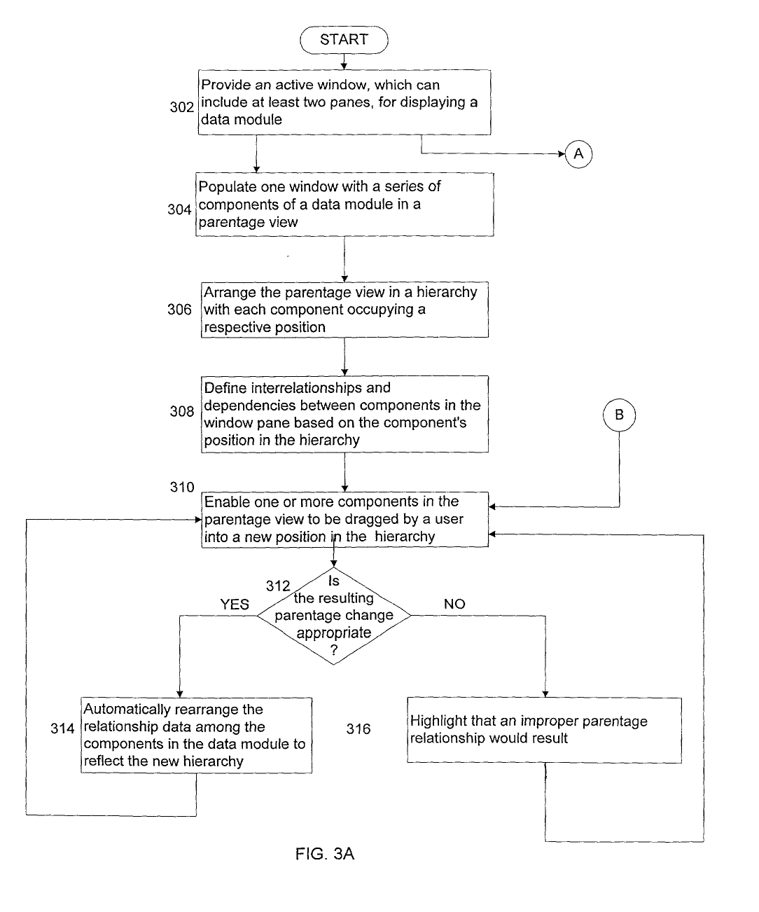

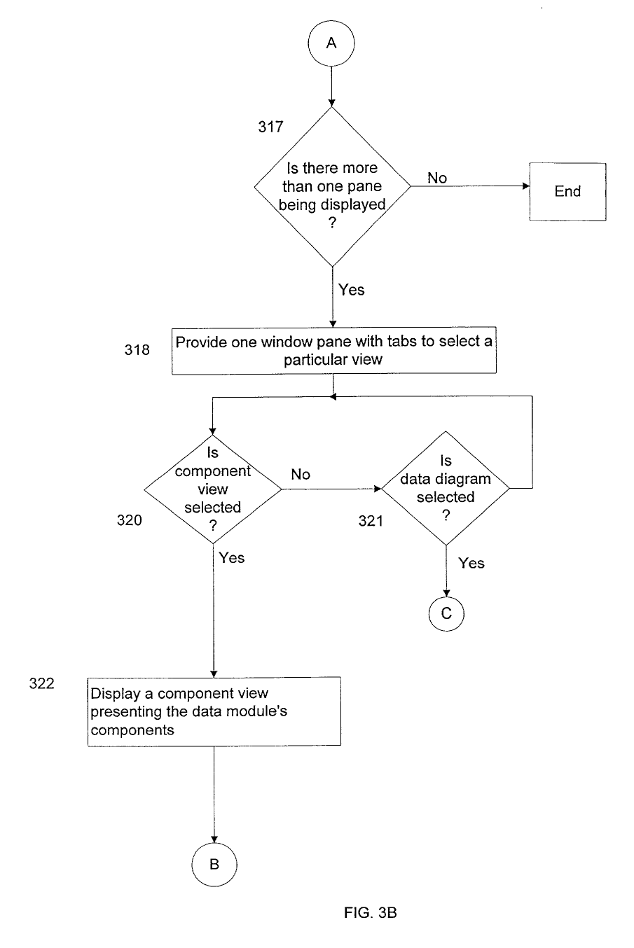

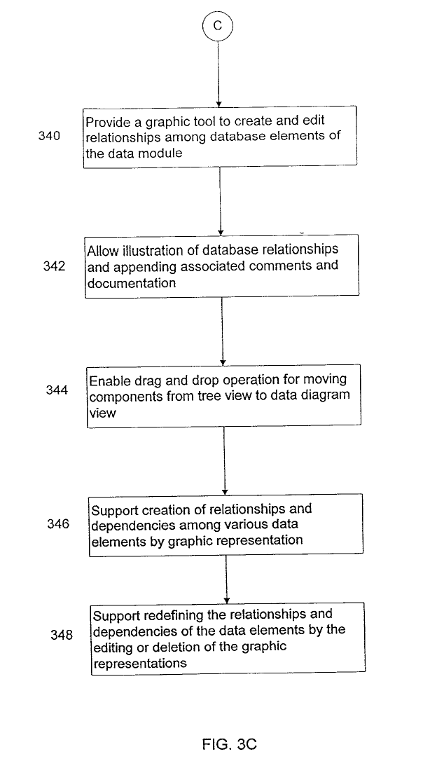

FIGS. 3A-3C diagram a user's interaction with an integrated development environment for designing a data module. When the data module designer opens an empty data module, the unit file for the new module is displayed in the code editor and the new module is added to the current project. An active window is opened at step 302 for displaying the data module. On the other hand, when an existing data module is re-opened, any existing components of the data module are displayed in the active window 100 of the data module designer.

The active window 100 may be only one pane or can include at least two panes 111, 120 for displaying the data module. In a single window pane implementation, the window is populated at step 304 with a series of components of the data module. These components include non-visual elements representing databases and the datasets that fall under these databases. The components and objects of the data module are arranged in a parentage view at step 306. The parentage view 111 is preferably a hierarchal tree, with each component occupying a respective position therein. The parentage view 111 shows the parent/child relationships and interrelationships of the components for the data module. The position of such components in the tree hierarchy is determined by these interrelationships and dependencies at step 308. The tree hierarchy comprises a top/down structure of nodes. There is only one route between nodes. Child components having the same parent are connected to the same node and preferably are all displayed with the same indentation in the tree. For example, databases fall under sessions and datasets fall under databases. In the tree view 111 of FIG. 1, the Fields dataset 114C falls under the Table database 114.

The user performs a drag-and-drop operation at step 310 to position datasets and data elements within the tree view 111 to position and redefine parent/child relationships. For example, the user can drag data sources from one table to another, databases from one session to another and datasets from one database to another. The embodiment of the drag-and-drop feature is controlled by the data module design system to limit such repositioning and relationship changes to changes in parentage that would make sense. The data module design system determines if the resulting parentage that would be appropriate at step 312 by reviewing component related information. If the new hierarchy is proper, the data module designer automatically rearranges the relationship data among the components in the data module to reflect the new hierarchy, as shown at step 314. If the resulting parentage change is appropriate, as tested at step 312, the component undergoes instantiation and takes on attributes of the parent as shown at step 314. Thus, if the new data source is dropped onto a table in the tree view from the palette, that data source automatically becomes a child of that table by setting its dataset property to the name of the table. The ability to perform drag-and-drop editing from the palette to the parentage view allows for rapid changes in overall data module design relationships.

The data module designer, at step 316, will highlight to the user that an improper relationship would result if the drop operation were completed. Notification to the user can be accomplished by highlighting the node the user is attempting to modify or by changing the icon for the mouse pointer to indicate the operation is not allowed. For example, a user is not able to change the parent of a menu into an action list. One of the aspects of the parentage view is that is allows the user to edit child components directly without having to go to a special editor.

There are times when having two views displayed is desired. In the preferred embodiment of this invention, the active window 100 includes two panes. One pane displays a tree view 111 of the hierarchy relationships, and the other pane 120 is provided with tabs 130, 140 for selecting different views. The data module designer allows selection of either the component view 131 or the data diagram view 141 by selecting the corresponding tab 130, 140.

With reference now to FIG. 3B, tabs 130, 140 are provided to the user in the active window 100 at step 318. If the component view is selected using the component view tab 130, as tested at step 320, the component view is displayed at step 322. Referring back to step 320, if the user selected a tab other than the component tab 130, the flow proceeds to step 321. Step 321 tests whether, for example, the data diagram tab 140 was selected. If the data diagram tab 140 was selected at step 318, as tested at step 321, then graphic tools are provided to the user in pane 120 for creating and editing relationships among the database objects, as shown at step 340.

The data diagram view 141 also provides a convenient window pane for documentation using allude relationships, as shown at step 342. Components appear on the data diagram view after the user performs a drag and drop operation from the tree view, as shown at step 344.

The data module design system supports a multiplicity of relationship types that can be created and edited within the data diagram view 141. The preferred embodiment of the invention permits graphical representation of property, master detail, look-up, allude and parent relationships, as indicated at step 346, through a standard GUI as described above. The data diagram view is a visual tool for creating and editing the relationships between database elements and for creating associated documentation.

The data diagram view 141 provides a graphic relationship of dependencies among the components. When a user removes components from the data diagram view, they are only removed from data diagram display. Components are not removed from the data module Components can be restored by dragging them from the tree view 111 back to the data diagram view 141. When a relationship, graphically represented by the lines in the diagram view, is removed from the data diagram view it is deleted from the project completely. The data module designer supports creation of relationships among the various data elements by using graphic tools available in the data diagram view.

The data module designer can graphically represent parentage relationships in the data diagram view 120 by a line having a hollowed arrow 148 pointing from a child to its parent. For example, customers 118 and orders 116 are both children of the master database 117. This is shown in the data diagram view 120 by a line with a hollowed arrow 148 pointing from the child “Customer” 118, to the parent “Mast” 117.

While the invention has been described in detail with particular reference to a preferred embodiment thereof, the invention is capable of other and different embodiments, and its details are capable of modifications in various obvious respects within the spirit and scope of the invention. Accordingly, the foregoing disclosure, description, and drawing figures are for illustrative purposes only, and do not in any way limit the invention, which is defined only by the claims.

What is claimed is:

1. A method for designing a data module, comprising the steps of:
a) presenting each of a series of components of a data module in a parentage view presented within a window on a display, said parentage view being hierarchically arranged, with each component occupying a respective position in said hierarchy;
b) enabling one or more of said components in the parentage view to be dragged by a user into a new position within the hierarchy; and
c) rearranging automatically the relationship data among said components in the data module once dropped into the new position in the hierarchy.

2. The method as in claim 1, wherein the parentage view is presented in a first pane of the window and wherein the window comprises at least one additional view.

3. The method as in claim 2, wherein the additional view is a component view which presents database elements that can be included in the hierarchy.

4. The method as in claim 3, including the additional step of populating the hierarchy with the database elements.

5. The method as in claim 1, including the additional step of confirming that the parentage change that would result from dropping one or more of the components into the new position is appropriate, prior to the step of rearranging the relationship data.

6. The method as in claim 1, including the additional steps of providing the user with a textual description of the data module and permitting a manual edit of a file containing a textual description of the data module that corresponds to the visual presentation of the parentage view.

7. The method as in claim 1, wherein the data module is a remote data module compatible with an application that includes three or more tiers.

8. The method as in claim 2, wherein the additional view is a data diagram view which presents a data diagram of database elements.

9. The method as in claim 8, including the additional step of populating the data diagram with database elements.

10. The method as in claim 9, wherein the population step is by a drag and drop operation from the parentage view into the data diagram.

11. The method as in claim 8, wherein the database elements have relationships and dependencies, the relationships and dependencies being graphically represented in the data diagram.

12. The method as in claim 11, wherein the relationships and dependencies of the database elements are created and deleted by editing the graphic representations.

13. The method as in claim 9, wherein the database elements have relationships and dependencies, the relationships and dependencies being graphically represented in the data diagram.

14. The method as in claim 13, wherein the relationships and dependencies of the database elements are created and deleted by editing the graphic representations.
